(19) United States
(12) Patent Application Publication
(10) Pub. No.: US 2020/0346730 A1
(43) Pub. Date: Nov. 5, 2020

(54) LIGHTER THAN AIR SYSTEM EMBODYING TETRAHEDRONS JOINED TO FORM LIFT- GENERATING SHELLS

(71) Applicant: Thomas Walter Pflasterer, Claysville, PA (US)

(72) Inventor: Thomas Walter Pflasterer, Claysville, PA (US)

(21) Appl. No.: 15/929,285

(22) Filed: Apr. 22, 2020

Related U.S. Application Data
(60) Provisional application No. 62/841,534, filed on May 1, 2019.

(51) Int. Cl. B64B 1/58; B64B 1/40

(52) U.S. Cl. CPC B64B 1/58; B64B 1/40

(57) ABSTRACT

A lift generation system embodying tetrahedral lifting cells capable of lift through the inflation of lighter than air gas. During an initial lift, the tetrahedral lifting cells may be assembled into larger geodesic shells. The assembled geodesic shell is capable of generating greater lift through filling the enclosed volume they defined with additional lighter than air gas.

### CROSS-REFERENCE TO RELATED APPLICATION

This application claims the benefit of priority of U.S. provisional application No. 62/841,534, filed 1 May 2019, the contents of which are herein incorporated by reference.

### BACKGROUND OF THE INVENTION

The present invention relates to lift generation systems and, more particularly, a modular lighter than air system embodying self-buoyant tetrahedral lifting cells adapted to form a shell during the lifting process, which in turn enables the assembled shell to generate further lift through filling the void defined by the shell with additional lighter than air gas.

The state of the art in lift generation for very heavy objects suggests a single, monolithic envelope that would be very heavy and thus difficult to fabricate and launch. Additionally, one fatal flaw in a lighter than air (LTA) balloon approach to this problem is the ‘ring loading’ problem, which concentrates great stress/load on a small circle of material at the crown during the partially inflated state. Resisting the local concentration of stress requires expensive materials. As a corollary, current LTA systems are limited in their operational size.

As can be seen, there is a need for a lift generation system embodying self-buoyant tetrahedral lifting cells capable of being assembled to form shells that are also fillable with LTA gas. This enables the assembled shell to generate lift while reducing stress concentrations as in the prior art. These self-buoyant cells can be assembled to launch and attain wind speed, with no additional stress incurred in the envelope while the greater shell is formed.

The modular nature allows mass production of small inflatable self-buoyant tetrahedral lifting cells which can be assembled for an initial lift into a larger structure through joining the tetrahedral lifting cells along abutting flat planar faces or along their respective corners, edges or vertices. Initially, the inflated (with LTA gas) tetrahedral lifting cells gain altitude, then are gathered to form the overall geodesic shell also fillable with lighter than air gas, which further generates greater lift.

### SUMMARY OF THE INVENTION

In one aspect of the present invention, a lift generation system includes: a plurality of tetrahedral cells, each tetrahedral cell joined along at least a corner to an adjacent tetrahedral cell of the plurality of tetrahedral cells in such a way that the plurality of tetrahedral cells forms a shell defining a volume.

In another aspect of the present invention, a method of launching a lift generation system includes the following: providing a plurality of tetrahedral cells; joining each tetrahedral cell along at least one corner to an adjacent tetrahedral cell of the plurality of tetrahedral cells in such a way that each tetrahedral cell has one planar face that is movable to be coplanar with another planar face of each adjacent tetrahedral cell so that said planar faces can simultaneously abut a supporting surface; filling at least one tetrahedral cell until there is an initial lift above the supporting surface of the plurality of tetrahedral cells; and joining three edges of each tetrahedral cell to the adjacent tetrahedral cell of the plurality of tetrahedral cells, wherein being movable to be coplanar with another planar face of each adjacent tetrahedral cell defines a Mercator style projection planar assembly on the ground.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention, illustrating a hexagonal subassembly of tetrahedrons;

FIG. 3 is a plan view of an exemplary embodiment of a single tetrahedron of the present invention;

FIG. 4 is a section view of an exemplary embodiment of the present invention, taken along line 4-4 of FIG. 3;

FIG. 5 is a two-dimensional view of an exemplary embodiment of a tetrahedron of the present invention;

FIG. 6 is a side view of an exemplary embodiment of the present invention having an equilateral triangle below the horizontal line and ⅓ of an equilateral triangle above the horizontal line; this pattern is the classic kite and is one of at least three two-dimensional panels to form one of the three-dimensional tetrahedrons of the present invention;

FIG. 7 is a perspective view of an exemplary embodiment of a dome assembly of a tetrahedral configuration of the present invention;

FIG. 8 is a perspective view of an exemplary embodiment of an elongated assembly configuration of tetrahedral cells of the present invention;

FIG. 9 is a flow chart of an exemplary embodiment of the present invention, filling and floating tetrahedron balloon and the larger geodesic shell; and

FIG. 10 is a top plan view of an exemplary embodiment of the present invention, illustrating the Mercator projection style planar assembly.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a lift generation system embodying tetrahedral lifting cells capable of lift through the inflation of lighter than air gas. During an initial lift, the tetrahedral lifting cells may be assembled into larger geodesic shells. Since the individual tetrahedrons are each self-buoyant, the assembled geodesic shell is capable of generating greater lift through filling the volume defined by the geodesic shell with additional lighter than air gas.

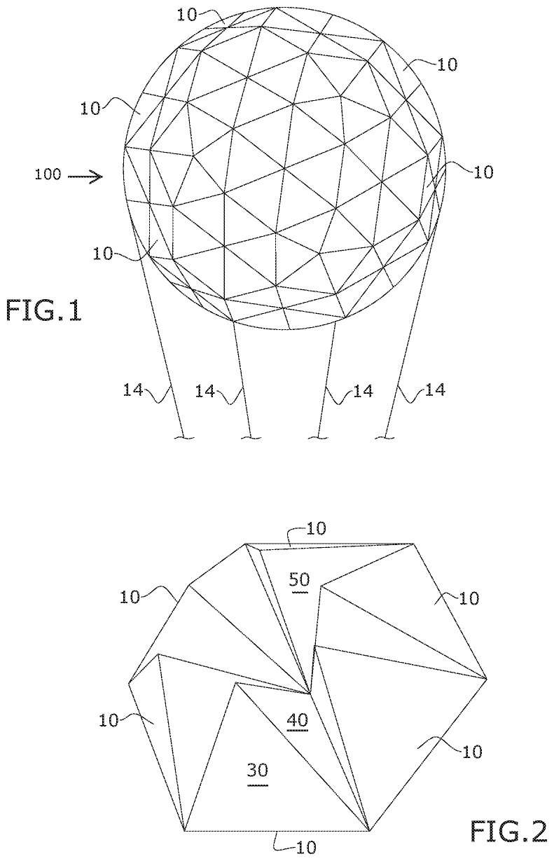

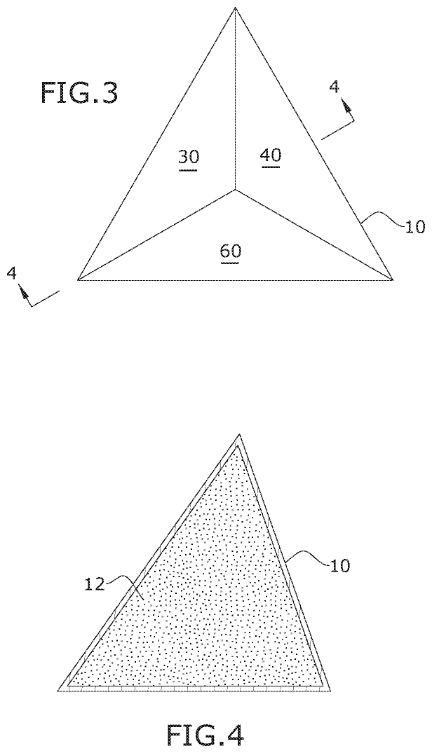

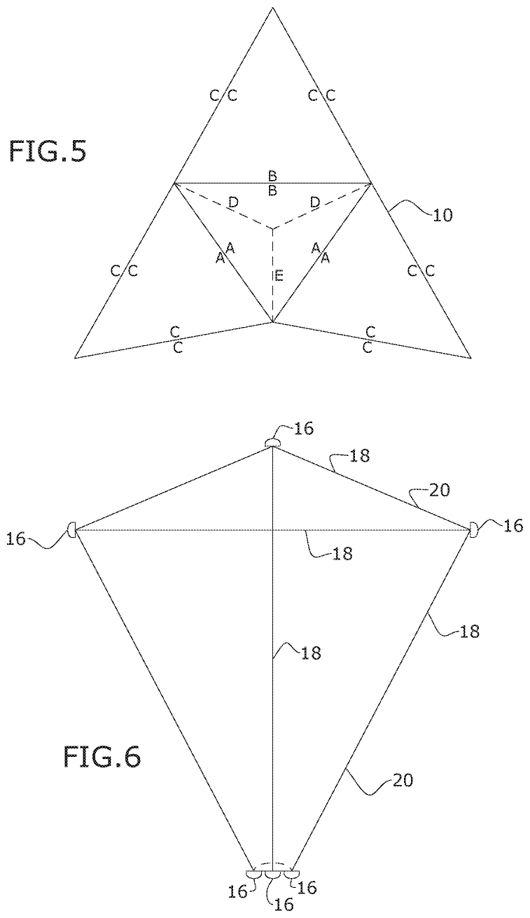

Referring now to FIGS. 1 through 10, the present invention includes a lift generation system embodying modular tetrahedral lifting cells 10 capable of being assembled to form larger geodesic shells during the lifting process, wherein the individual tetrahedrons are each self-buoyant, enabling the assembled shell to generate greater lift meanwhile filling the volume defined by the geodesic shell with additional lighter than air (LTA) gas 12.

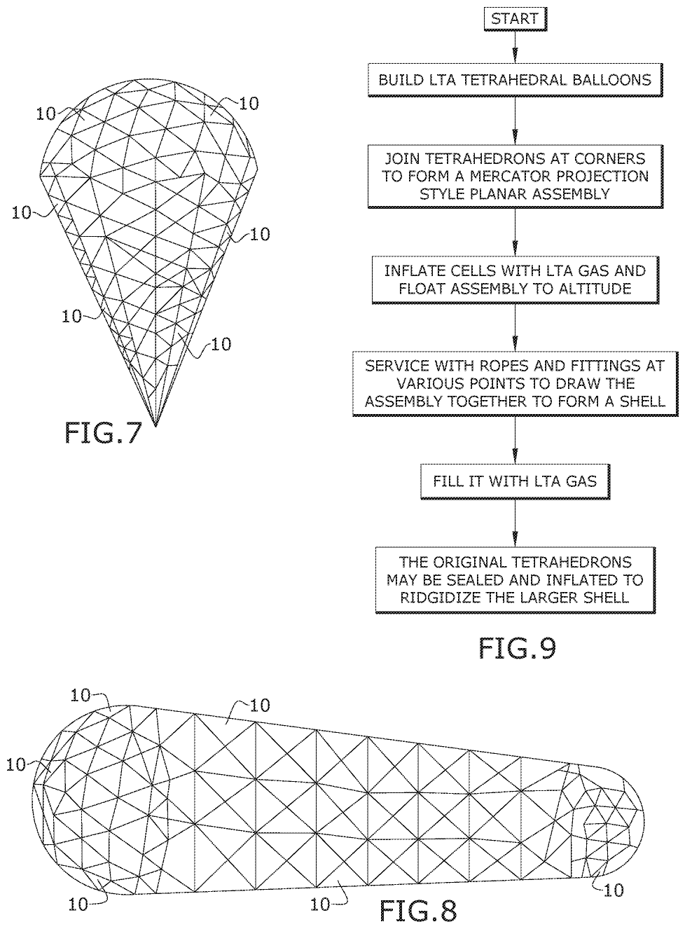

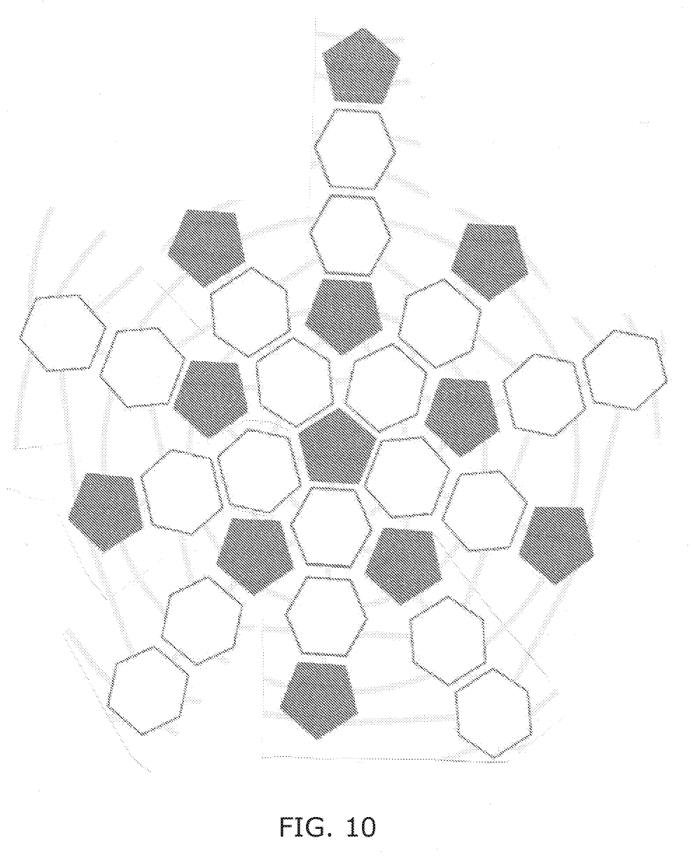

The tetrahedral lifting cells 10 are LTA tetrahedron inflatables having a plurality of faces 30, 40, 50, and 60 providing edges, corners, and vertices for joining to adjacent tetrahedral lifting cells 10, as illustrated in FIG. 2. The tetrahedral lifting cells 10 can also be joined at their corners, edges or vertices forming a Mercator projection style planar assembly of hexagonal and pentagonal subassemblies on the ground, as illustrated in FIG. 10. Then this planar assembly can be made Lighter than air and allowed to gain altitude. In certain embodiments, the present invention includes tethers 14 and fittings 16 (such as D-rings) at various corners, edges or vertices of each tetrahedral lifting cells 10 to allow the assembly to be drawn together while in flight so as to form the larger geodesic shell 100, for instance an icosidodecahedron (aka a soccer ball) from 180 individual tetrahedrons making 12 hexagonal and 20 pentagonal sub assemblies. Of course, the arrangement of the tetrahedral lifting cells 10 and their plurality of coextensive joining faces 30, 40, 50, and 60 enable other elongated (non-spheroidal) assemblies to be formed, as non-exclusively illustrated in FIGS. 7 and 8. Once the large geodesic shell 100 is formed, lifting gas 12 may fill the interior volume defined by the plurality of joined tetrahedral lifting cells 10.

The smaller tetrahedral lifting cells 10 may be sealed and inflated above ambient pressure to make the larger shell rigid. Additionally, adjacent tetrahedral lifting cells 10 may be sealed along their joining seams 20 by load tape 18 or other sufficient joining techniques prior to volume-inflation or soon thereafter to rigidize the larger shell.

The individual tetrahedral lifting cells 10 may be assembled by state-of-the-art methods used for sport hot air balloons or other inflatable structures, including but not limited to such as alternate materials including various films or fabrics to be used and joined with tapes, glue or by welding. The individual tetrahedral lifting cells 10 could be any shape that would lend themselves to joining into a larger shell. Individual tetrahedral lifting cells 10 could be joined into larger sub-assemblies to make final assembly at altitude simpler.

The tetrahedral lifting cells 10 may contain any LTA gas 12. Once the larger geodesic shell 100 is assembled in flight it too may contain any LTA gas 12. The individual tetrahedral lifting cells 10 or smaller assemblies of multiple individual tetrahedral lifting cells 10 or sub-assemblies could be piloted by human pilots or by remote control. The human pilots could perform the assembly of the larger geodesic shell 100 at altitude or by remote control. The original human pilots could leave the large shell to be piloted by a single pilot or by a small group or via remote control.

Also, the present invention can create an assembled large lighter than air shell, which could form a static lift crane to be used for heavy lifting near the ground or to carry lighter loads to extreme altitude. Furthermore, propulsion could be added to create an airship.

Additionally, since the present invention embodies the concept of buoyancy, the primary market is lighter than air applications, but the present invention would also work in water for lifting objects from the deep ocean.

It should be understood, of course, that the foregoing relates to exemplary embodiments of the invention and that modifications may be made without departing from the spirit and scope of the invention as set forth in the following claims.

What is claimed is:

1. A lift generation system, comprising:
a plurality of tetrahedral cells, each tetrahedral cell joined along at least a corner to an adjacent tetrahedral cell of the plurality of tetrahedral cells in such a way that the plurality of tetrahedral cells forms a shell defining a volume.

2. The lift generation system of claim 1, further comprising:
each tetrahedral cell is lighter than air.

3. The lift generation system of claim 1, further comprising:
each tetrahedral cell is filled at least in part with a lighter than air gas.

4. The lift generation system of claim 3, further comprising:
the volume is filled at least in part with lighter than air gas.

5. The lift generation system of claim 1, further comprising:
a two-dimensional representation of a tetrahedral cell formed by joining their edges with an adhesive, by welding or by mechanical means.

6. The lift generation system of claim 5, further comprising:
one or more sub-assemblies of multiple tetrahedral cells joined at their vertices and/or along their edges.

7. A method of launching a lift generation system, comprising:
providing a plurality of tetrahedral cells;
joining each tetrahedral cell along at least one corner to an adjacent tetrahedral cell of the plurality of tetrahedral cells in such a way that each tetrahedral cell has one planar face that is movable to be coplanar with another planar face of each adjacent tetrahedral cell so that said planar faces can simultaneously abut a supporting surface;
filling at least one tetrahedral cell until there is an initial lift above the supporting surface of the plurality of tetrahedral cells; and
joining three edges of each tetrahedral cell to the adjacent tetrahedral cell of the plurality of tetrahedral cells.

8. The method of claim 7, wherein being movable to be coplanar with another planar face of each adjacent tetrahedral cell defines a mercator projection style planar assembly on the ground.
